(19) United States
(12) Patent Application Publication
(10) Pub. No.: US 2026/0204532 A1
(43) Pub. Date: Jul. 16, 2026

(54) DETECTOR INLET AND SAMPLING METHOD

(71) Applicant: SMITHS DETECTION-WATFORD LIMITED, Hemel Hempstead (GB)

(72) Inventor: Ben Irwin, Hemel Hempstead (GB)

(21) Appl. No.: 19/136,624

(22) PCT Filed: Dec. 8, 2023
(86) PCT No.: PCT/GB2023/053166

§ 371 Date: Jun. 6, 2025

(30) Foreign Application Priority Data
Dec. 8, 2022 (GB) 2218500.3

(51) Int. Cl. H01J 49/04; G01N 1/22; G01N 1/40

(52) U.S. Cl. CPC H01J 49/049; G01N 1/2247; G01N 1/405

(57) ABSTRACT

Inlet apparatus for providing sample analyte vapour to a detector, the apparatus comprising: a sample receiving portion (110); a heater (120); a vapour pre-concentrator (130); and a sampling inlet (140); wherein the sample receiving portion is arranged to receive a flow of gas carrying aerosol sample analytes and the heater is arranged to heat the aerosol sample analytes to provide sample analyte vapour; and wherein the apparatus is arranged to provide said sample analyte vapour to both: (i) the vapour pre-concentrator, and (ii) a said detector via the sampling inlet.

### TECHNICAL FIELD

The present disclosure relates to the field of sample detection.

### BACKGROUND

There are numerous different detection techniques for identifying the presence of a substance of interest in a given sample. Implementations of these techniques may be used for detecting the presence of chemical warfare agents (‘CWA’) or toxic industrial chemicals (‘TIC’), or any other chemical of interest, including, for example, explosives and their precursors. Spectrometers may be used to identify one or more properties of sample analytes (i.e. components of a sample to be analysed), and an indication of one or more substances present in the sample may be determined based on such identified properties of the sample analytes. In some instances, the sample to be analysed must be in a vapour form for the detector to work as intended. In which case, vapour will be passed to the detector, and the detector will measure one or more properties of this vapour (and detect the presence of a substance of interest on the basis of these measured properties). For example, in an ion mobility spectrometer (‘IMS’) or in a mass spectrometer (‘MS’), ionised molecules may be identified based on their mobility in a carrier buffer gas or air, or based on other properties. Detection devices are known which utilise these techniques for detecting the presence of hazardous or illegal materials, such as CWAs and TICs.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect, there is provided an inlet apparatus for providing sample analyte vapour to a detector. The apparatus comprising: a sample receiving portion; a heater; a vapour pre-concentrator; and a sampling inlet. The sample receiving portion is arranged to receive a flow of gas carrying aerosol sample analytes and the heater is arranged to heat the aerosol sample analytes to provide sample analyte vapour. The apparatus is arranged to provide said sample analyte vapour to both: (i) the vapour pre-concentrator, and (ii) a said detector via the sampling inlet.

Embodiments may facilitate improved accuracy, reliability, and speed for the detection of any substances of interest in aerosol sample analytes. For instance, aerosols which are present in smaller quantities may be detected more reliably after a larger quantity of such vapourised aerosols have accumulated on the vapour pre-concentrator. At the same time, aerosols which are present in greater quantities may be detected concurrently with accumulating vapour on the pre-concentrator. In other words, the apparatus may be configured to enable simultaneous sample detection (by the detector for vapour sampled via the sampling inlet) and sample accumulation (of sample vapour on the vapour pre-concentrator). For both vapour sampling and vapour accumulation, the vapour comprises vapourised aerosols (e.g. where those aerosols were vapourised in the inlet apparatus by the heater).

The apparatus may be configured to desorb sample analyte vapour accumulated on the vapour pre-concentrator to provide desorbed sample analyte vapour. The apparatus may be configured to provide said desorbed sample analyte vapour to said detector via the sampling inlet. The apparatus may be configured to operate in: (i) a first mode in which sample analyte vapour from the heated aerosol sample analytes is provided to said detector via the sampling inlet; and (ii) a second mode in which desorbed sample analyte vapour from the vapour pre-concentrator is provided to said detector via the sampling inlet. When operating in the first mode, the apparatus may be configured to simultaneously accumulate some of the sample analyte vapour (from the heated aerosol sample analytes) on the vapour pre-concentrator (as well as providing some of that sample analyte vapour to the detector). The apparatus may be configured to operate in the first mode for a selected time period before switching to the second mode.

The apparatus may be configured to reduce a rate of flow of the gas through the apparatus when switching from the first mode to the second mode. The apparatus may be configured to inhibit the flow of gas through the apparatus when operating in the second mode. For example, in response to switching from the first mode to the second mode, the apparatus may be configured to reduce (e.g. stop) flow through the apparatus, e.g. by disengaging or reducing operation of an air mover of the apparatus.

The apparatus may be configured to heat the vapour pre-concentrator to provide desorption therefrom. The vapour pre-concentrator may comprise a vapour pre-concentrator heater. The pre-concentrator may be configured to accumulate vapour on an external surface thereof. The external surface may comprise a silicone material. The external surface of the pre-concentrator may at least partially surround the heater (e.g. it may completely circumscribe it). Heating of the vapour pre-concentrator may be inhibited in the first mode.

The vapour concentrator may be located between the sample receiving portion and the sampling inlet. The heater may be arranged across a flow path from the sample receiving portion towards the vapour pre-concentrator and sampling inlet. A flow path through the apparatus may comprise at least one bend. At least a portion of the vapour pre-concentrator may be located on an outside of the bend. The apparatus may be arranged to provide sample vapour to an ion mobility spectrometer. The sampling inlet may comprise a pinhole inlet and/or a membrane covering. The apparatus may comprise two vapour pre-concentrators and/or two sampling inlets.

In an aspect, there is provided a detector configured to detect the presence of one or more substances of interest in sample analyte vapour, the detector having an inlet apparatus and a detection portion. The inlet apparatus comprises: a sample receiving portion; a heater; a vapour pre-concentrator; and a sampling inlet. The sample receiving portion is arranged to receive a flow of gas carrying aerosol sample analytes and the heater is arranged to heat the aerosol sample analytes to provide sample analyte vapour. The apparatus is arranged to provide said sample analyte vapour to both: (i) the vapour pre-concentrator, and (ii) the detector portion via the sampling inlet. The detection portion is configured to detect the presence of one or more substances of interest in sample analyte vapour received from the sampling inlet.

In an aspect, there is provided a method of providing sample analyte vapour to a detector, the method comprising: receiving a flow of gas carrying aerosol sample analytes in an inlet apparatus; heating the aerosol sample analytes to provide sample analyte vapour; and providing said sample analyte vapour to both: (i) a vapour pre-concentrator in the inlet apparatus, and (ii) a said detector via a sampling inlet in the inlet apparatus.

Said sample analyte vapour may be provided to the vapour pre-concentrator for a selected time period before the sample analyte vapour accumulated on the vapour pre-concentrator is desorbed therefrom to provide desorbed sample analyte vapour. Methods may comprise providing the desorbed sample analyte vapour from the pre-concentrator to said detector via the sampling inlet. Desorbing the sample analyte vapour from the vapour pre-concentrator to provide the desorbed sample analyte vapour may comprise heating the vapour pre-concentrator. When heating the vapour pre-concentrator, a rate of gas flow through the inlet apparatus may be reduced.

In an aspect, there is provided a method of operating a detector to detect the presence of one or more substances of interest in sample analyte vapour, the method comprising: receiving a flow of gas carrying aerosol sample analytes; heating the aerosol sample analytes to provide sample analyte vapour; providing said sample analyte vapour to both: (i) a vapour pre-concentrator, and (ii) a detector via a sampling inlet; and operating the detector to detect the presence of one or more substances of interest in the sample analyte vapour received from the sampling inlet.

Aspects of the present disclosure may comprise one or more computer program products comprising computer program instructions configured to program a controller to operate an inlet apparatus and/or a detector to implement any of the methods disclosed herein.

### FIGURES

Some examples of the present disclosure will now be described, by way of example only, with reference to the figures, in which:

FIG. 1 shows a schematic diagram of an inlet apparatus.

FIG. 2 shows a schematic diagram of an inlet apparatus.

FIG. 3 shows a schematic diagram of an ion mobility spectrometer.

In the drawings like reference numerals are used to indicate like elements.

### SPECIFIC DESCRIPTION

The present disclosure relates to systems and methods for providing sample analyte vapour to a detector. An incoming flow of gas from a sample to be analysed will flow through an inlet apparatus. This flow of gas through the inlet apparatus may contain sample analytes in the form of sample analyte vapour and/or sample analyte aerosols. The incoming flow of gas is heated to generate sample analyte vapour from the aerosols. Some of the sample analyte vapour in the inlet apparatus is then provided to a detector (via a sampling inlet in the inlet apparatus) and some of the sample analyte vapour in the inlet apparatus will accumulate on a vapour pre-concentrator in the inlet apparatus. As such, sample vapour may simultaneously accumulate on the vapour pre-concentrator and be provided to the detector via the sampling inlet. Periodically, vapour which has accumulated on the vapour pre-concentrator may be desorbed therefrom, and some of this desorbed vapour may then be provided to the detector via the sampling inlet. Vapour desorbed from the pre-concentrator will be at a higher concentration, and so sample analytes which are at a relatively low concentration in the gas flow may be detected more reliably. Meanwhile, higher concentration analytes can still be detected by the detector while the vapour analytes are also accumulating on the vapour pre-concentrator.

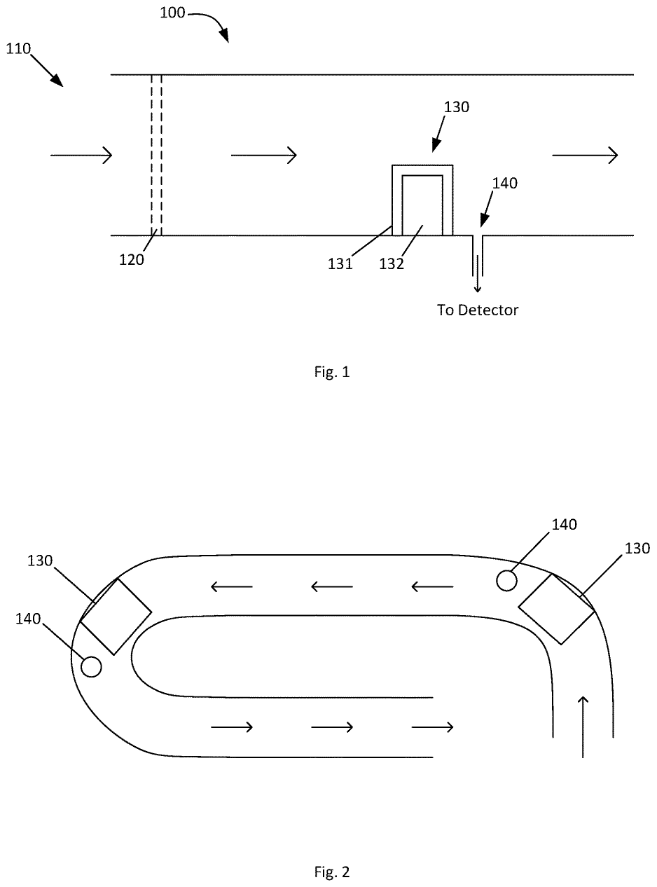

An example of an inlet apparatus will now be described with reference to FIG. 1.

FIG. 1 shows an inlet apparatus 100. The apparatus 100 includes a sample receiving portion 110, a heater 120, a vapour pre-concentrator 130 and a sampling inlet 140. The vapour pre-concentrator 130 includes a surface 131 and a desorber 132. The arrows in FIG. 1 show an example flow through the apparatus 100.

The apparatus 100 defines a flow path for the flow of fluids/aerosols through the apparatus 100. The apparatus 100 may include a housing which defines (e.g. circumscribes) this flow path. For example, the housing may provide a conduit through which the fluids and aerosols will flow. Flow through the apparatus 100 will be from an upstream location to a downstream location.

The sample receiving portion 110 is located at an upstream location of the apparatus 100. The heater 120 is located upstream of the vapour pre-concentrator 130/sampling inlet 140. The heater 120 is located between the sample receiving portion 110 and the vapour pre-concentrator 130/sampling inlet 140.

The heater 120 is located across the flow path through the apparatus 100. The heater 120 may comprise a resistive heater. The heater 120 may provide an aerosol heater. The heater 120 may be formed of a plurality of electrical conductors (of relatively high electrical resistance). The conductors may be arranged in a mesh or ‘grid-like’ pattern. The conductors of the heater 120 may span across the flow path (e.g. they may extend across the full cross-section of the conduit that provides the flow path). For example, the heater 120 may comprise a plurality of elongate conductive elements extending across the sample receiving portion 110. The conductive elements may be arranged in a grid such as a mesh or a knitmesh. The conductors may be arranged to at least partially interrupt the flow of air through the inlet apparatus 100 (e.g. between the sample receiving portion 110 and the vapour pre-concentrator 120). The conductive elements may be arranged to provide a surface of heater which in contact with the flow of air which is greater than an internal surface of the sample receiving portion 110).

The vapour pre-concentrator 130 is located downstream of the heater 120 and upstream of the sampling inlet 140. In other words, the vapour pre-concentrator 130 is located between the heater 120 and the sampling inlet 140. The vapour pre-concentrator 130 may be located adjacent to (e.g. just before) the sampling inlet 140. The separation of the vapour pre-concentrator 130 and the sampling inlet 140 may be such that desorbed vapour from the vapour pre-concentrator 130 will be proximal to the sampling inlet 140.

The vapour pre-concentrator 130 is formed of the surface 131 and the desorber 132. The desorber 132 may be in the form of a heater. The desorber 132 is located proximal to the surface 131 (e.g. to enable the desorber 132 to provide heating of the surface 131). The surface 131 may at least partially surround the desorber 132 (e.g. it may completely surround the desorber 132). The surface 131 may be silicone based. For example, the vapour pre-concentrator 130 may be formed of a silicone-covered heating element. The surface 131 is located in the flow path through the apparatus 100. For example, the surface 131 may protrude into the conduit that provides the flow path. The surface 131 is arranged to provide an obstruction to flow along the flow path.

The sampling inlet 140 is located downstream of the vapour pre-concentrator 130. The sampling inlet 140 is for coupling the inlet apparatus 100 (and the flow path therethrough) to a detector. When the inlet apparatus 100 is coupled to a detector, a flow path is provided from the sampling inlet 140 to the detector. In other words, the sampling inlet 140 may provide a flow path coupling between the inlet apparatus 100 and the detector. The sampling inlet 140 may comprise a pinhole inlet. For example, a pinhole may be provided in the body of the inlet apparatus 100 which defines the flow path (e.g. which provides the conduit through which fluids/aerosols flow). The sampling inlet 140 may optionally comprise a membrane covering.

The inlet apparatus 100 is configured for gas to flow through the flow path through the inlet apparatus 100. For example, although not shown, the apparatus 100 may include an air mover configured to selectively provide flow through the apparatus 100. The air mover may comprise a pump or a fan. Additionally, or alternatively, the air mover may be provided by a separate component to the inlet apparatus 100. The apparatus 100 (e.g. the air mover) may be arranged to provide a flow of gas from the sample receiving portion 110 towards the heater 120, vapour pre-concentrator 130 and sampling inlet 140. The apparatus 100 is arranged for the flow to be heated by the heater 120 and for this heated flow to be directed towards the vapour pre-concentrator 130 and sampling inlet 140.

The sample receiving portion 110 is arranged to receive sample analytes. The sample analytes comprise sample substance(s) which are to be analysed by the detector to which the inlet apparatus 100 is coupled. The sample receiving portion 110 is arranged to receive a flow of gas containing sample analytes. The sample analytes may be in vapour and/or aerosol form. The gas flow may carry sample analyte vapour as well as sample analyte aerosols. The sample receiving portion 110 may provide an opening for sample analytes into the flow path through the inlet apparatus 100. For example, the sample receiving portion 110 may be configured to receive sample analytes from e.g. a swab.

The heater 120 is arranged to heat the sample analytes. In particular, the heater 120 is arranged to heat sample analyte aerosols to generate sample analyte vapour therefrom. In other words, the heater 120 is arranged to increase the proportion of sample analytes that are in vapour form. The heater 120 is arranged to heat the substances flowing from the sample receiving portion 110 towards the vapour pre-concentrator 130 and sampling inlet 140. The heater 120 is arranged to provide sample analyte vapour from sample analyte aerosols so that the sample analyte substances provided to the vapour pre-concentrator 130/sampling inlet 140 are in vapour form.

The vapour pre-concentrator 130 is configured to accumulate sample analyte vapour. For example, sample analyte vapour may be adsorbed onto the surface 131 of the vapour pre-concentrator 130. In other words, the vapour pre-concentrator 130 is arranged to store some of the sample analyte vapour flowing through the inlet apparatus 100. The vapour pre-concentrator 130 is arranged to retain said sample analyte vapour on the surface 131 (and to also accumulate further sample analyte vapour on its surface 131 over time). As such, the vapour pre-concentrator 130 is arranged to store some of the sample analyte vapour which has entered into the inlet apparatus 100. As will be appreciated in the context of the present disclosure, the concentration of sample analytes in the gas flowing through the inlet apparatus 100 may vary depending on the sample to be analysed (among other things). At any one time, the concentration of sample analyte vapour in the inlet apparatus 100 which could be provided to the detector (via the sampling inlet 140) may vary. The vapour pre-concentrator 130 is arranged to store sample analyte vapour to provide an increase concentration of stored sample analyte vapour (e.g. as stored on the surface 131 of the vapour pre-concentrator 130).

In other words, the vapour concentrator is arranged to accumulate sample analyte vapour in the inlet apparatus 100. The vapour concentrator is selectively operable to desorb such sample analyte vapour therefrom to provide desorbed sample analyte vapour in the inlet apparatus 100. For this, the desorber 132 is configured to interact with the surface 131 to provide desorption of sample analyte vapour therefrom. For example, the desorber 132 may comprise a heater, and that heater may be configured to heat the surface 131 to desorb sample analyte vapour therefrom (to provide desorbed sample analyte vapour). As will be appreciated, by desorbing such sample vapour from the vapour pre-concentrator 130, the resulting concentration of sample analyte vapour in the inlet apparatus 100 will be increased (due to the sudden influx of desorbed sample analyte vapour). In other words, the vapour concentrator may be configured to: (i) accumulate sample analyte vapour, and then (ii) offload desorbed sample analyte vapour.

The sampling inlet 140 is arranged to provide sample analyte vapour from the flow path in the inlet apparatus 100 to the detector. The sampling inlet 140 may be selectively operable to permit/inhibit flow to the detector. The sampling inlet 140 may be arranged to inhibit unintended flow through to the detector. For example, where the sampling inlet 140 includes a pinhole, the apparatus 100 (or the detector to which the apparatus 100 is connected) may be configured to apply a negative pressure to draw vapour in through the pinhole (where the normal flow of gas through the inlet apparatus 100 would not result in flow into the sampling inlet 140). In other words, the apparatus 100 (or the detector to which it is connected) may be configured to select when sample analytes are to be transmitted to the detector for analysis thereof (and when they are not). The sampling inlet 140 is operable to actively draw in vapour from the flow path through the inlet apparatus 100 (and to provide that vapour to the detector).

The apparatus 100 is configured to selectively use the vapour pre-concentrator 130 for either: (i) accumulating sample analyte vapour, and (ii) offloading sample analyte vapour. The apparatus 100 may be configured to switch between these two modes of operation (e.g. between accumulating and offloading).

When being used for accumulating sample analyte vapour, the apparatus 100 is configured to simultaneously provide: (i) sample analyte vapour to the vapour pre-concentrator 130, and (ii) sample analyte vapour to the detector through the sampling inlet 140. In other words, the apparatus 100 is configured to operate in a first (e.g. accumulating) mode in which sample analyte vapour is simultaneously accumulated on the vapour pre-concentrator 130 and also provided to the detector (via the sampling inlet 140). In this first mode of operation, some of the sample analyte vapour in the inlet apparatus 100 will be stored by the vapour pre-concentrator 130, and some will be analysed by the detector. Some, or all, of the sample vapour in the inlet apparatus 100 (which is stored on the vapour pre-concentrator 130 and/or provided to the detector) will have been received in the inlet apparatus 100 in aerosol form, but will be in vapour form after having been heated by the heater 120.

When being used for offloading sample analyte vapour, the apparatus 100 is configured to: (i) desorb vapour from the vapour pre-concentrator 130 to provide desorbed sample analyte vapour, and (ii) provide some of the desorbed sample analyte vapour to the detector for analysis thereof. The desorption and the providing of desorbed sample analyte vapour to the detector may occur concurrently, or they may occur sequentially. For example, the apparatus 100 may be configured to simultaneously desorb the analyte vapour and provide vapour to the detector, or the apparatus 100 may be configured to first commence desorption of analyte vapour before commencing providing desorbed sample analyte vapour to the detector. In other words, the apparatus 100 is configured to operate in a second (e.g. offloading) mode in which sample analyte vapour which had been stored by the vapour pre-concentrator 130 is analysed by the detector. In this second mode of operation, analyte vapour being analysed by the detector will be that from the pre-concentrator 130 (e.g. whereas in the first mode of operation, the analyte vapour being analysed will be that which is not being accumulated on the vapour pre-concentrator 130).

Flow through the inlet apparatus 100 will be provided when operating in the first mode of operation. In the first mode of operation, the apparatus 100 may thus be configured for sample analyte vapour to flow towards the vapour pre-concentrator 130/sampling inlet 140 from the heater 120. The vapour pre-concentrator 130 is arranged to receive some of this sample analyte vapour, and the sampling inlet 140 may be configured to obtain some of this sample analyte vapour and to provide that sample analyte vapour to the detector. The remaining sample analyte vapour may continue flowing along the flow path (after the sampling inlet 140) and towards an outlet of the apparatus 100. In the first mode of operation, the desorber 132 may be in an inactive state (e.g. the heater may be turned off). The vapour pre-concentrator 130 may thus be arranged to facilitate accumulation, rather than offloading, of sample analyte vapour in the first mode of operation.

Flow through the inlet apparatus 100 may be reduced, or stopped altogether, when operating in the second mode of operation. In the second mode of operation, the through flow of sample analyte vapour will be reduced. For example, the air mover be inactive. The desorber 132 is configured to drive desorption of sample analyte vapour from the vapour pre-concentrator 130. The resulting desorbed sample analyte vapour will be less likely to flow away downstream. The sampling inlet 140 may be operated to actively draw in some of this desorbed sample analyte vapour to be provided to the detector. In this mode, the vapour pre-concentrator 130 may thus be configured to facilitate offloading, rather than accumulation, of sample analyte vapour.

Although not shown, the apparatus 100 (or the detector to which it is connected) may include a controller. The controller may be configured to control operation of components of the inlet apparatus 100 and/or detector. For example, the controller may be configured to control the heater 120 to selectively provide heating of sample analyte aerosols. The controller may be configured to control the desorbed to selectively provide desorption of sample vapour from the vapour pre-concentrator 130. The controller may be configured to control operation of the air mover to provide or inhibit flow through the inlet apparatus 100. The controller may be configured to control operation of the detector and/or the sampling inlet 140 to actively draw vapour through the sampling inlet 140 (e.g. to apply negative pressure at the sampling inlet 140).

The controller may be configured to control operation of such components to control the apparatus 100 to operate in the first and second modes. For example, the controller may be configured to control operation of the different components to switch between the first and second modes of operation. The controller may be configured to control the apparatus 100 to operate in the first mode of operation for a selected time period (e.g. before then switching the apparatus 100 to operate in the second mode of operation).

The controller may be configured to control operation in the first mode so that: (i) the air mover is active to generate air flow through the inlet apparatus 100, (ii) the heater 120 is active for generating sample analyte vapour from sample analyte aerosols, (iii) the desorber 132 is inactive to facilitate accumulation of sample analyte vapour on the vapour pre-concentrator 130, and (iv) some sample analyte vapour is actively drawn from the inlet apparatus 100 through the sampling inlet 140 to be provided to the detector.

The controller may be configured to control operation in the second mode so that: (i) the air mover may be inactive and/or generating a reduced flow rate through the inlet apparatus 100 (as compared to the first mode), (ii) the heater 120 may optionally be inactive, (iii) the desorber 132 is active to facilitating desorption of sample analyte vapour therefrom (e.g. so that desorbed sample analyte vapour is present in the inlet apparatus 100 proximal to the sampling inlet 140), and (iv) some sample analyte vapour is actively drawn from the inlet apparatus 100 through the sampling inlet 140 to be provided to the detector.

In operation, the inlet apparatus 100 may commence in its first mode of operation.

In this first mode of operation, gas from the sample to be analysed is received at the sample receiving portion 110 of the inlet apparatus 100. This gas contains some sample analyte aerosols. The gas, and any sample analyte aerosols it carries, flow along the flow path through the inlet apparatus 100. The heater 120 heats this flow (which has come from the sample receiving portion 110). As a result of heating, some of the sample analyte aerosols are vapourised to provide sample analyte vapour. This sample analyte vapour flows along the flow path in the inlet apparatus 100. Some of this sample analyte vapour accumulates on the surface 131 of the vapour pre-concentrator 130. This accumulated sample analyte vapour will remain on the surface 131 (e.g. as long as the desorber 132 remains inactive). Some of the sample analyte vapour in the inlet apparatus 100 (i.e. which has not accumulated on the surface 131 of the vapour pre-concentrator 130) is provided to the detector for analysis thereof. For this, vapour from the inlet apparatus 100 flow path may be actively drawn through the sampling inlet 140, e.g. by application of a negative pressure to suck in some of this vapour through the sampling inlet 140. This vapour accumulation on the vapour pre-concentrator 130, and the sampling of this vapour through the sampling inlet 140, occurs simultaneously. As such, sample analysis may be performed for some sample analyte vapour from the inlet apparatus 100 while other sample analyte vapour in the inlet apparatus 100 is accumulating on the vapour pre-concentrator 130.

Operation in this first mode may continue for a selected time period. During this time period, gas may continue to flow through the inlet apparatus 100 flow path. As such, sample analytes (e.g. aerosols) will continue to enter the inlet apparatus 100, be vapourised into sample analyte vapour, and then accumulate on the vapour pre-concentrator 130. Over time, the vapour pre-concentrator 130 will effectively store sample analyte vapour at a higher concentration than is present in the gas flow through the inlet apparatus 100. The selected time period may be selected so that sufficient time has elapsed for a significant amount of sample analyte vapour to have accumulated on the vapour pre-concentrator 130 (e.g. to enable any relevant substances of interest to be identifiable by the detector in the resulting desorbed sample analyte vapour).

During this first mode of operation, the detector may analyse one or more sample portions obtained through the sampling inlet 140 (and from the flow path of the inlet apparatus 100). Based on the analysis of these one or more sample portions, an indication of the presence (or absence) of any substance(s) of interest may be identified in the sample. If any substances of interest are present in relatively large quantities in sample, then it is likely that sample analyte vapour indicative of those substances will have been obtained from the inlet apparatus 100 (through the sampling inlet 140) and then analysed during operation in the first mode. As a result, any substances of interest which are present in large quantities may reliably be detected by the detector. However, for any substance(s) of interest only present in the sample in relatively small quantities, it may be less likely that these could be reliably identified by the detector, as the concentration of sample vapour analytes for these substances will be much lower.

To facilitate more reliable detection of these substances, the apparatus 100 may then switch to operation in the second mode.

In the second mode of operation, the flow rate through the inlet apparatus 100 is reduced. For example, the air mover may be turned off (or turned to a lower power level). As a result, air flow through the flow path of the inlet apparatus 100 will be significantly reduced as compared to the first mode of operation. Optionally, the heater 120 may be turned off (or turned to a lower power level) during operation in the second mode (e.g. because there will be fewer, or no, sample analyte aerosols passing the heater 120 to be vapourised). The desorber 132 will be turned on. When active, the desorber 132 will cause desorption of sample analyte vapour from the vapour pre-concentrator 130. For example, the desorber 132 may commence heating of the surface 131 of the vapour pre-concentrator 130. Operation of the desorber 132 causes desorption of vapour from the vapour pre-concentrator 130 to provide desorbed sample analyte vapour.

Operation of the desorber 132 may give rise to a cloud of desorbed sample analyte vapour. As the vapour pre-concentrator 130 is located adjacent to the sampling inlet 140, and the air flow through the inlet apparatus 100 is significantly reduced, there may be a high concentration of desorbed sample analyte vapour proximate to the sampling inlet 140. One or more sample vapour portions are then drawn through the sampling inlet 140 to be provided to the detector (e.g. through application of a negative pressure). The portion(s) to be analysed by the detector may thus contain a relatively high concentration of desorbed sample analyte vapour. As the desorbed sample analyte vapour was accumulated over an extended time period, this will typically contain a higher concentration of any potential substances of interest in the sample being analysed. The detector may therefore be operated to analyse a vapour sample which contains a higher proportion of desorbed sample analyte vapour. This may thus facilitate more reliable detection of substances (particularly aerosols) which are only in present in the sample to be analysed in relatively small quantities.

After vapour samples to be analysed have been obtained, the apparatus 100 may switch back to operation in the first mode. For this, the heater 120 may be turned on again (if it was turned off), the desorber 132 may be turned off, and the flow through the inlet apparatus 100 may be increased.

The arrangements described above (and corresponding methods of operation) may enable concurrent detection of relatively high concentration substances of interest (i.e. in the first mode of operation) with detection of relatively low concentration substances of interest (i.e. in the second mode of operation). That is, when operating in the first mode, substances of interest may be detected by the detector (especially those present in higher quantities). While this is happening some substances of interest (including those present in lower quantities) may be accumulating on the vapour pre-concentrator 130. The apparatus 100 may then switch to operation in the second mode, where higher concentration sampling is performed (i.e. on the desorbed sample analyte vapour). The lower concentration substances may then be identified based on analysis of this higher concentration sample.

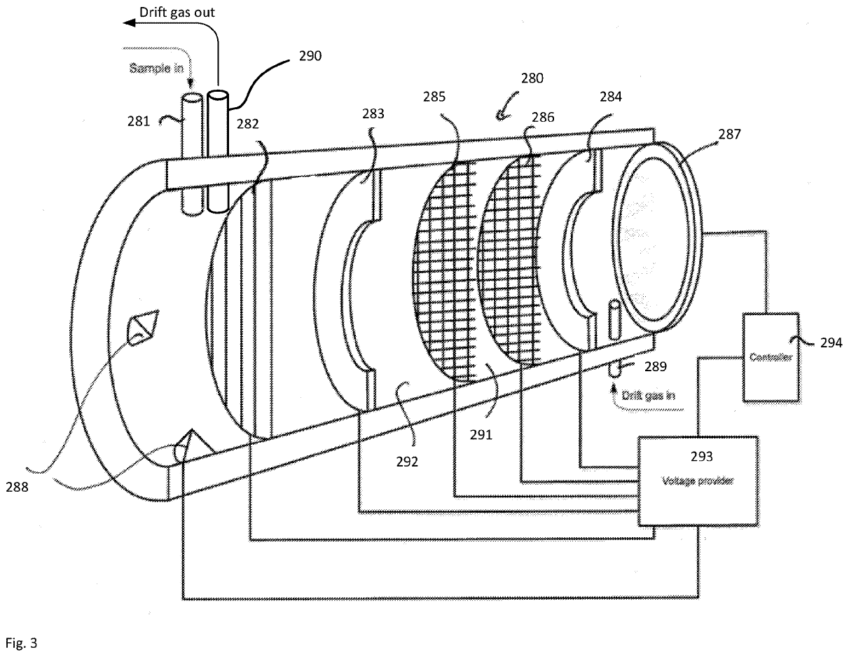

FIG. 2 shows another inlet apparatus. The apparatus of FIG. 2 is similar to that of FIG. 1. FIG. 1 shows an example inlet apparatus in cross-section (when viewed side on). FIG. 2 shows a portion of an inlet apparatus when viewed in plan. The arrows show the direction for flow through the inlet apparatus.

As can be seen in FIG. 2, the inlet apparatus defines a tortuous flow path for the flow of fluid/aerosols. The flow path includes at least one bend (a couple are shown in FIG. 2). The apparatus also includes two vapour pre-concentrators 130 and two sampling inlets 140. Each vapour pre-concentrator 130 is arranged with an associated sampling inlet 140. The arrangement of each vapour pre-concentrator 130/sampling inlet 140 pair is the same as that described above with reference to FIG. 1. That is, each vapour pre-concentrator 130 is arranged upstream of, and adjacent to, its associated sampling inlet 140. Additionally, each vapour pre-concentrator 130 is located on a bend of the flow path. In particular, each vapour pre-concentrator 130 is located on an outside region of the bend (e.g. on the radially outward side of the bend). Each vapour pre-concentrator 130 may be located on a portion of the bend which immediately follows a straight section of flow path. Each vapour pre-concentrator 130 may be arranged in a region of the inlet apparatus where flow is more turbulent. Each sampling inlet 140 may be located immediately downstream of that vapour pre-concentrator 130.

Operation of the apparatus may be the same as that described above, with each of the two modes of operation are each performed simultaneously for the two pairs of vapour pre-concentrators and sampling inlets. That is, each vapour pre-concentrator 130 and sampling inlet 140 may operate in the first mode of operation for a selected time period. After the selected time period has elapsed, both vapour pre-concentrators 130/sampling inlets 140 may be switched into the second mode of operation.

Examples described herein relate to a detector inlet apparatus 100. The inlet apparatus 100 is configured to provide sample analyte vapour to a detector. The apparatus 100 is configured to vapourise sample analyte aerosols to provide sample analyte vapour, and to provide some of this resulting sample analyte vapour to the detector through the sampling inlet 140. Some of the vapourised sample analyte vapour will be provided directly to the detector and some will be provided via being accumulated on the vapour pre-concentrator 130 and then being desorbed therefrom. For both the first and second mode of operation, the sample analytes provided to the detector will be in vapour form.

It will be appreciated in the context of the present disclosure that the particular type of detector need not be considered limiting. The detector is configured to identify the presence of one or more substances of interest in the sample. The detector may comprise an ion analyser. The detector may comprise a spectrometer. For example, the detector may comprise an ion mobility spectrometer or a mass spectrometer. Inlet apparatuses of the present disclosure may find particular utility for providing sample vapour to an ion mobility spectrometer, an example of which will now be described with reference to FIG. 3.

FIG. 3 is an illustration of a part section through a detector in the form of an ion mobility spectrometer (‘IMS’) 280.

The ion mobility spectrometer 280 illustrated in FIG. 3 includes an ioniser 288 that is separated from a drift chamber 292 by a gate 282. The gate 282 can control passage of ions from the ioniser 288 into the drift chamber 292. As illustrated, the IMS 280 includes an inlet 281 for enabling material to be introduced from the sample of interest to the ioniser 288 (e.g. via the sampling inlet 140 of the inlet apparatus 100).

In the example illustrated in FIG. 3, the drift chamber 292 lies between the ioniser 288 and a detector 287, so that ions can reach the detector 287 by traversing the drift chamber 292. The drift chamber 292 may comprise a series of drift electrodes 283, 284 for applying a voltage profile along the drift chamber 292 to move ions from the ioniser 288 along the drift chamber 292 toward the detector 287.

The IMS 280 may be configured to provide a flow of drift gas in a direction generally opposite an ion's path of travel to the detector 287. For example, the drift gas can flow from adjacent the detector 287 toward the gate 282. As illustrated, a drift gas inlet 289 and drift gas outlet 290 can be used to pass drift gas through the drift chamber. Example drift gases include, but are not limited to, nitrogen, helium, air, air that is re-circulated (e.g., air that is cleaned and/or dried) and so forth.

The detector 287 may be coupled to provide a signal to a detection controller 294. Current flow from the detector 287 can be used by the controller 294 to infer that ions have reached the detector 287, and a characteristic of the ions can be determined based on the time for ions to pass from the gate 282 along the drift chamber 292 to the detector 287. Examples of a detector 287 are configured to provide a signal indicating that ions have arrived at the detector 287. For example, the detector may comprise a conductive electrode (such as a Faraday plate).

Electrodes 283, 284 may be arranged to guide ions toward the detector 287, for example the drift electrodes 283, 284 may comprise rings which may be arranged around the drift chamber 292 to focus ions onto the detector 287. Although the example of FIG. 3 includes only two drift electrodes 283, 284, in some examples a plurality of electrodes may be used, or a single electrode may be used in combination with the detector 287 to apply an electric field to guide ions toward the detector 287.

The spectrometer 280 is shown comprising ion modifier electrodes 285, 286 arranged in the drift chamber, although it is to be appreciated in the context of this disclosure that these may not be included.

As shown in FIG. 3 a voltage provider 293 is coupled to be controlled by the controller 294. The voltage provider 293 may also be coupled to provide voltages to the ioniser 288 to enable material from a sample to be ionised. In an embodiment the voltage provider 293 is coupled to the gate electrode 282 to control the passage of ions from the ionisation chamber into the drift chamber 292. The voltage provider 293 can be coupled to the drift electrodes 283, 284 for providing a voltage profile for moving ions from the ioniser 288 toward the detector 287.

As noted above, the drift electrodes 283, 284 may provide a voltage profile that moves ions along the drift chamber so that the ions travel from the ioniser toward the detector. As illustrated in FIG. 3, the first ion modifier electrode 285 and the second ion modifier electrode 286 can be spaced apart in the direction of travel of the ions.

The spectrometer and the voltage provider may be contained in a common housing. In spectrometry ion counts may be measured by peaks on a spectrum, and the height of a peak may be an indicator of the number of ions reaching the detector at a particular time. Ions which are produced by ions which are produced by reactions of the neutral molecules of the substance of interest may be termed “daughter ions”, and ions from which daughter ions are produced may be termed “parent ions”.

As noted above, other types of detector may be used. For example, a mass spectrometer may be used such as a time of flight mass-spectrometer. In such spectrometers ions mass to charge ratio may be inferred from their time of flight through a vacuum. In other types of mass spectrometer, ions maybe separated in other ways based on their mass to charge ratios, for example by deflection under electric or magnetic fields.

A detection apparatus including the detector and the inlet apparatus may be provided in a portable unit. For example, the detection apparatus may be handheld.

It will be appreciated in the context of the present disclosure that the vapour pre-concentrator 130 may be provided in any suitable form. For this, the vapour pre-concentrator 130 includes a portion for accumulating sample vapour (e.g. surface 131) and a component for driving desorption of sample vapour therefrom (e.g. desorber 132). The desorber 132 may comprise a heater for causing desorption by heating, but other forms for the desorber 132 could be provided. For example, the desorber 132 may be configured to subject the surface 131 to radiation, pressure, vibration etc. so as to cause desorption of sample vapour therefrom. The surface 131 may contain an adsorbent material (e.g. to which sample analytes will bind during an adsorption phase). The surface 131 may have an adsorbent coating. For example, the vapour pre-concentrator 130 may comprise a heating element which has an adsorbent coating. The surface 131 (e.g. the adsorbent coating) may be silicone-based.

As described herein, the heater 120 may be provided by a resistive heater in the form of a mesh grid of conductors arranged across the inlet flow path. However, it is to be appreciated that this should not be considered limiting, as other forms of heater could be provided. For example, a radiative heater could be used (e.g. an IR heater). Similarly, in examples, an air mover is provided for controlling air flow through the inlet apparatus. It will be appreciated that the air mover may be provided as part of the inlet apparatus, or it may be provided by a separate component. For example, the air mover could be provided by a component which couples the sample to the inlet apparatus (e.g. to blow air through the inlet apparatus from the sample) or the air mover could be located downstream of the sampling inlet (e.g. to suck air through the inlet apparatus).

It will be appreciated from the discussion above that the examples shown in the figures are merely exemplary, and include features which may be generalised, removed or replaced as described herein and as set out in the claims. With reference to the drawings in general, it will be appreciated that schematic functional block diagrams are used to indicate functionality of systems and apparatus described herein. Additionally, the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some examples the function of one or more elements shown in the drawings may be integrated into a single functional unit.

As will be appreciated by the skilled reader in the context of the present disclosure, each of the examples described herein may be implemented in a variety of different ways. Any feature of any aspects of the disclosure may be combined with any of the other aspects of the disclosure. For example, method aspects may be combined with apparatus aspects, and features described with reference to the operation of particular elements of an apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Equivalents and modifications not described above may also be employed.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Other examples and variations of the disclosure will be apparent to the skilled addressee in the context of the present disclosure.

1. An inlet apparatus for providing sample analyte vapour to a detector, the apparatus comprising:
a sample receiving portion;
a heater;
a vapour pre-concentrator; and
a sampling inlet;
wherein the sample receiving portion is arranged to receive a flow of gas carrying aerosol sample analytes and the heater is arranged to heat the aerosol sample analytes to provide sample analyte vapour; and
wherein the apparatus is arranged to provide said sample analyte vapour to both: (i) the vapour pre-concentrator, and (ii) a said detector via the sampling inlet.

2. The apparatus of claim 1, wherein the apparatus is configured to desorb sample analyte vapour accumulated on the vapour pre-concentrator to provide desorbed sample analyte vapour.

3. The apparatus of claim 2, wherein the apparatus is configured to provide said desorbed sample analyte vapour to said detector via the sampling inlet.

4. The apparatus of claim 3, wherein the apparatus is configured to operate in:
a first mode in which sample analyte vapour from the heated aerosol sample analytes is provided to said detector via the sampling inlet; and
a second mode in which desorbed sample analyte vapour from the vapour pre-concentrator is provided to said detector via the sampling inlet.

5. The apparatus of claim 4, wherein the apparatus is configured to operate in the first mode for a selected time period before switching to the second mode.

6. The apparatus of claim 4 or 5, wherein the apparatus is configured to reduce a rate of flow of the gas through the apparatus when switching from the first mode to the second mode.

7. The apparatus of claim 6, wherein the apparatus is configured to inhibit the flow of gas through the apparatus when operating in the second mode.

8. The apparatus of any of claims 2 to 7, wherein the apparatus is configured to heat the vapour pre-concentrator to provide desorption therefrom.

9. The apparatus of claim 8, wherein the vapour pre-concentrator comprises a vapour pre-concentrator heater.

10. The apparatus of claim 9, wherein the pre-concentrator is configured to accumulate vapour on an external surface thereof, optionally wherein the external surface comprises a silicone material.

11. The apparatus of claim 10, wherein the external surface of the pre-concentrator at least partially surrounds the heater.

12. The apparatus of any of claims 8 to 11, wherein heating of the vapour pre-concentrator is inhibited in the first mode.

13. The apparatus of any preceding claim, wherein the vapour concentrator is located between the sample receiving portion and the sampling inlet.

14. The apparatus of any preceding claim, wherein the heater is arranged across a flow path from the sample receiving portion towards the vapour pre-concentrator and sampling inlet.

15. The apparatus of any preceding claim, wherein a flow path through the apparatus comprises at least one bend.

16. The apparatus of claim 15, wherein at least a portion of the vapour pre-concentrator is located on an outside of the bend.

17. The apparatus of any preceding claim, wherein the apparatus is arranged to provide sample vapour to an ion mobility spectrometer and/or wherein the sampling inlet comprises a pinhole inlet and/or a membrane covering.

18. The apparatus of any preceding claim, wherein the apparatus comprises two vapour pre-concentrators and/or two sampling inlets.

19. A detector configured to detect the presence of one or more substances of interest in sample analyte vapour, the detector having an inlet apparatus and a detection portion, wherein the inlet apparatus comprises:
a sample receiving portion;
a heater;
a vapour pre-concentrator; and
a sampling inlet;
wherein the sample receiving portion is arranged to receive a flow of gas carrying aerosol sample analytes and the heater is arranged to heat the aerosol sample analytes to provide sample analyte vapour;
wherein the apparatus is arranged to provide said sample analyte vapour to both: (i) the vapour pre-concentrator, and (ii) the detector portion via the sampling inlet; and
wherein the detection portion is configured to detect the presence of one or more substances of interest in sample analyte vapour received from the sampling inlet.

20. A method of providing sample analyte vapour to a detector, the method comprising:
receiving a flow of gas carrying aerosol sample analytes in an inlet apparatus;
heating the aerosol sample analytes to provide sample analyte vapour; and
providing said sample analyte vapour to both: (i) a vapour pre-concentrator in the inlet apparatus, and (ii) a said detector via a sampling inlet in the inlet apparatus.

21. The method of claim 20, wherein said sample analyte vapour is provided to the vapour pre-concentrator for a selected time period before the sample analyte vapour accumulated on the vapour pre-concentrator is desorbed therefrom to provide desorbed sample analyte vapour.

22. The method of claim 21, wherein the method comprises providing the desorbed sample analyte vapour from the pre-concentrator to said detector via the sampling inlet.

23. The method of claim 22, wherein desorbing the sample analyte vapour from the vapour pre-concentrator to provide the desorbed sample analyte vapour comprises heating the vapour pre-concentrator; and
wherein when heating the vapour pre-concentrator, a rate of gas flow through the inlet apparatus is reduced.

24. A method of operating a detector to detect the presence of one or more substances of interest in sample analyte vapour, the method comprising:
receiving a flow of gas carrying aerosol sample analytes;
heating the aerosol sample analytes to provide sample analyte vapour;
providing said sample analyte vapour to both: (i) a vapour pre-concentrator, and (ii) a detector via a sampling inlet; and
operating the detector to detect the presence of one or more substances of interest in the sample analyte vapour received from the sampling inlet.

25. A computer program product comprising computer program instructions configured to program a controller to operate an inlet apparatus and/or a detector to implement the method of any of claims 20 to 24.
